(19) United States
(12) Patent Application Publication
(10) Pub. No.: US 2008/0289253 A1
(43) Pub. Date: Nov. 27, 2008

(54) Covers for Plant and Flower Containers

(76) Inventor: Patti D. Rubin, Aventura, FL (US)

Correspondence Address: RADER, FISHMAN & GRAUER PLLC, 10653 SOUTH RIVER FRONT PARKWAY, SUITE 150, SOUTH JORDAN, UT, 84095, US

(21) Appl. No.: 12/125,624

(22) Filed: May 22, 2008

Related U.S. Application Data
(60) Provisional application No. 60/939,547, filed on May 22, 2007.

(51) Int. Cl. A01G 9/02

(52) U.S. Cl. 47/72; 47/66.6

(57) ABSTRACT

A flower pot cover is configured to be secured to a flower pot and provide substantial benefit over tradition uncovered flower pots. A flower pot cover provides distinguishing information regarding the contents of the flower pot, information regarding the recipient or giver of the flower pot, superior gripping surface, and/or protection to the flower pot and the surface upon which it is disposed. A flower pot cover also provides tactile feedback as well as communicating information visually.

### RELATED APPLICATIONS

This application claims the benefit under 35 U.S.C. § 119(e) of U.S. Provisional Patent Application No. 60/939,547 filed May 22, 2007 titled “FLOWER POT COVER.” The provisional application is incorporated herein by reference in its entirety.

### TECHNICAL FIELD

The present exemplary system and method relates to flower pot covers. More particularly, the present exemplary system and method relates to fabric and other material covers configured to be secured to the exterior of flower pots.

### BACKGROUND

Flower pots have traditionally been used to hold soil within which plants are to be grown. Flower pots are made from a wide variety of materials including ceramics, glasses, clays, plastics, metals, and a variety of other suitable materials. In many instances, the flower pot adequately performs the function of containing the soil and water within which the plant is growing, but fails to match the décor or seasonal designs used by the plant's owner. To change the appearance of the flower pot and plant combination, the plant owner must repot the plant in a different flower pot that more closely matches the décor or seasonal design. Repotting the plant subjects the plant to damage and trauma as the soil and roots are removed from the old flower pot and placed in the new flower pot.

Often small flower pots are moved by the owner from one location to another. Traditional flower pot materials are often slippery resulting in flower pots being dropped. Dropping a flower pot may result in damage to the flower pot, escapement of the soil and water within, and/or damage to the plant. Additionally, in many circumstances it is difficult to distinguish one flower pot from another flower pot. This is especially true as most flower pots are mass-produced and appear identical.

When flower pot and plant combinations are given as gifts, the giver may desire to communicate additional information about the gift or convey other sentiments. Because flower pots are mass produced and look identical, the flower pot itself fails to convey information or sentiments regarding the motivation for giving the flower pot and plant combination. This becomes especially apparent when a planted seed is given as a gift as traditional flower pots would appear as a simple pot with nothing more than soil.

### SUMMARY

A fabric flower pot cover is joined to the exterior of a flower pot. According to various embodiments, the flower pot covers include a wide variety of designs and utilize various geometries. Furthermore, according to several embodiments, the flower pot covers are configured to perform one or more specific functions. For instance, according to one embodiment a flower pot cover is configured to prevent soil and/or water from contacting the surface upon which the flower pot is disposed.

According to another embodiment, the flower pot cover is configured to improve the health of the plant contained therein. It may be beneficial to the health of the plant in a number of ways, including providing insulation from fluctuating temperatures. Additionally, a removable flower pot cover allows the appearance of the flower pot to be changed without repotting the plant, thereby avoiding trauma due to repotting. The addition of the flower pot cover may also improve safety during plant handling. According to one embodiment, the flower pot cover provides a non-slip surface by which the flower pot may be grasped, reducing the potential for breakage of the flower pot and spillage of the soil. Additionally the flower pot cover may provide added insulation, thereby improving the health of the plant by maintaining a more constant temperature within the pot. In this exemplary embodiment, an insulating material may form the flower pot cover, or alternatively, may be disposed between two materials to retain the insulating material. According to this exemplary embodiment, the insulating material may include, but is in no way limited to, synthetic materials such as polystyrene, polyicynene, polyurethane, polyisocyanurate; aerogel; mineral wools such as fibre-glass, rockwool, slagwool; minerals such as vermiculite or perlite; natural plant materials such as cellulose insulation, cork, hemp, cotton, straw, straw dust, woodchips, sawdust; and/or animal fibers such as wool.

According to one exemplary embodiment, the removable flower pot cover increases the amount of visual and tactile information communicated by the flower pot. Flower pots are often mass-produced having virtually identical appearances. Unique flower pot covers allow easy identification of specific flower pots and the plants or seeds they contain. For instance if the flower pot contained seeds for catnip and had a flower pot cover made of fabric with cats printed on it, it would convey the information about the contents of the flower pot and its future crop. Furthermore, plants contained in flower pots often have emotional significance to their owners. Plants are also commonly given as gifts to communicate feelings. According to one embodiment a flower pot covers assists in this communication and gift giving process by allowing additional information to be conveyed through the flower pot cover.

According to yet another embodiment, the flower pot cover may be additionally configured to preserve the integrity and shape of the flower pot it covers and/or protect the surfaces that support the flower pot. In the case of coconut fiber pots, the flower pots naturally decompose due to the action of sunlight, water, and microorganisms. A flower pot cover can extend the life of these naturally biodegradable flower pots and maintain the shape of the flower pot by protecting it from sunlight and giving additional structural support. The flower pot covers may also be configured to minimize the amount of water and/or soil that spills from the flower pot during handling or shipping. Additionally, the flower pot covers prevent moisture from leaking through that would potentially cause damage to carpet, furniture, tile, and other surfaces upon which the flower pot and its cover are disposed. The flower pot covers also provide protection for the plant and the pot from abrasion and impact. Several materials used commonly in traditional flower pots easily shatter when dropped, resulting in soil and water spilling in addition to possible damage to the plant. A flower pot cover, according to one embodiment, is configured to help prevent the breakage of flower pots, or in the event of a break, secure the contents from spilling and protecting the plant.

### BRIEF DESCRIPTION OF THE DRAWINGS

The accompanying drawings illustrate various embodiments of the present system and method and are a part of the specification. The illustrated embodiments are merely examples of the present system and method and do not limit the scope thereof.

FIGS. 1A and 1B illustrate a flower pot suitable to grow plants from a top and bottom view respectively, according to one exemplary embodiment.

FIGS. 2A, 2B, and 2C respectively illustrate a flower pot cover from a side, top perspective, and a bottom view, according to various exemplary embodiments.

FIGS. 3A, 3B, and 3C are illustrations of an exemplary material that is used to create a flower pot cover, and intermediate steps forming a flower pot cover form the material, according to one exemplary embodiment.

FIG. 3D is a drawing illustrating a rolled sheet of material including attachment mechanisms on two ends of the material, according to exemplary embodiments.

FIG. 4 is an illustration of a rolled sheet of material used to create a flower pot cover including a bottom portion, according to one exemplary embodiment.

FIGS. 5A and 5B illustrate a flower pot cover including a bottom being secured to a flower pot, according to one exemplary embodiment.

FIGS. 6A and 6B illustrate a flower pot cover, including a bottom, being secured to a flower pot by a cord through eyelets, according to one exemplary embodiment.

FIG. 7 illustrates a flower pot cover with grip surfaces secured to a flower pot, according to one exemplary embodiment.

FIGS. 8A, 8B, and 8C illustrate a flower pot cover being secured to a flower pot, wherein the cover is taller than the pot and is configured to surround the upper lip of the flower pot, according to one exemplary embodiment.

Throughout the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

### DETAILED DESCRIPTION

An exemplary system and method for covering traditional flower pots and other containers used to house soil in which seeds and plants grow is provided herein. Several unique embodiments of the present exemplary system and method are provided; however, any individual embodiment may be used exclusive of, or in conjunction with, one or more alternative embodiments. Additionally, as referred to throughout the specification and claims, a flower pot cover is disclosed as being configured to be secured to a flower pot, this is according to some exemplary embodiments. It is understood that the presently disclosed flower pot cover may be easily adapted for use with any container or pot, not exclusively containers holding plants.

Numerous specific details are set forth for purposes of explanation and to provide a thorough understanding of the present system and method for implementing a flower pot cover. It will be apparent, however, to one skilled in the art, that the present products and methods may be practiced without these specific details. Reference in the specification to “one embodiment” or “an embodiment” means that a particular feature, structure, or characteristic described in connection with the embodiment is included in at least one embodiment. The appearance of the phrase “in one embodiment” in various places in the specification are not necessarily all referring to the same embodiment.

Unless the context requires otherwise, throughout the specification and claims which follow, the word “comprise” and variations thereof, such as, “comprises” and “comprising” are to be construed in an open, inclusive sense, that is as “including, but not limited to.”

The following description is presented to illustrate and describe several embodiments of the present exemplary system and method; it is not intended to limit the system and method to any exact form disclosed in conjunction with the various embodiments. The following description will explain in detail several features of the present exemplary system and method according to various exemplary embodiments.

The present system and method provides a flower pot cover configured to be secured to a flower pot and thereby provide one or more specific functional features. According to one exemplary embodiment, a flower pot cover is removably secured to a flower pot. That is, it is adequately secured to the flower pot, but may be easily removed as desired. Accordingly, according to one embodiment, the easy removal of the flower pot cover allows for maintenance and cleaning of the flower pot cover. According to one exemplary embodiment, the flower pot cover provides structural support during or after structural failure of a flower pot. Particularly, the flower pot cover may be configured to prevent leakage of soil and water. Additionally the flower pot cover may provide a superior gripping surface as compared to the uncovered flower pot. According to several embodiments, the flower pot cover may be specifically and uniquely configured to convey emotional or sentimental attachment. The flower pot cover may convey emotions and sentiments through visual means as well as through, according to one embodiment, features providing tactile feedback. Ultimately several methods of constructing a flower pot cover are described, as well as several methods of securing a flower pot cover to a flower pot. The preceding specific functions are associated with the present exemplary system, according to several of its various embodiments. Consequently, each will be described below in detail, followed by a description of exemplary methods of construction and securement of a flower pot cover to a flower pot.

### EXEMPLARY EMBODIMENTS

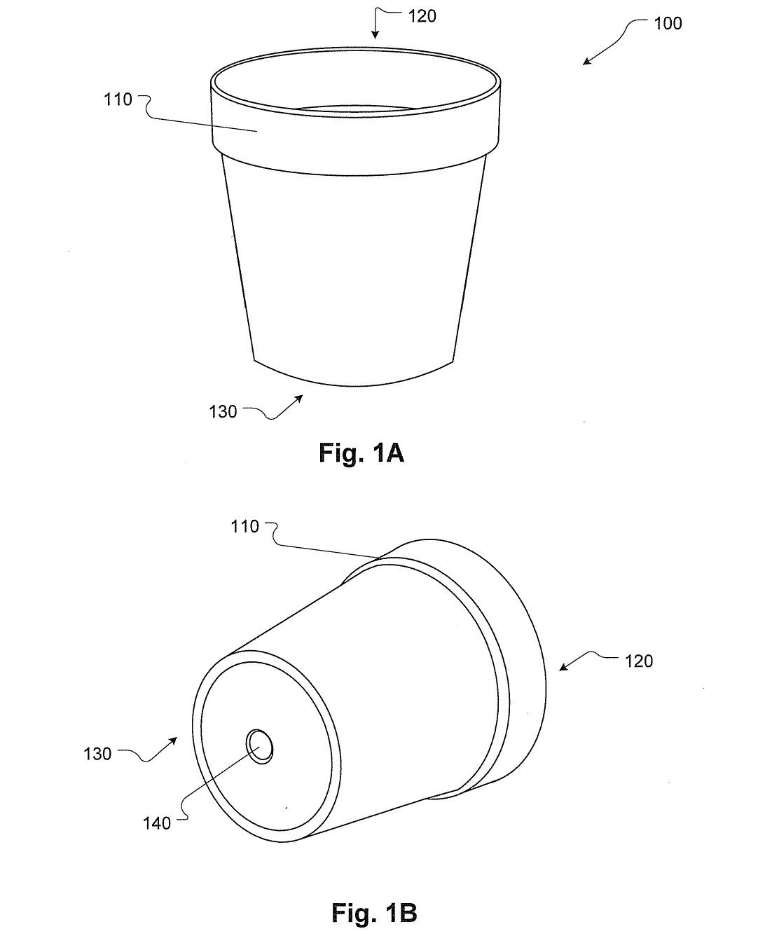

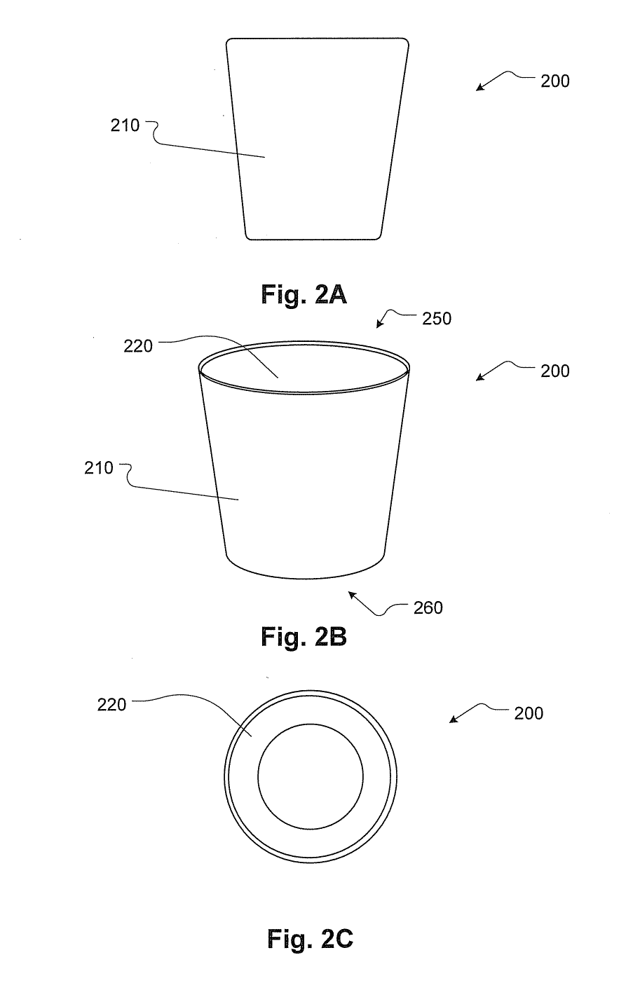

According to one exemplary embodiment, a flower pot cover is configured to be secured to a traditional flower pot (100, FIGS. 1A and 1B). The flower pot cover may be constructed of a variety of materials. According to one exemplary embodiment, the flower pot cover is configured to be easily removed from the flower pot and washed. A flower pot cover, according to one exemplary embodiment, substantially envelopes the outer perimeter of the flower pot. Flower pot covers (200), as illustrated in FIG. 2A-2C, may be configured to perform a specific function; regardless of their intended use it is probable that the flower pot covers (200) will become dirty. For this reason, according to one exemplary embodiment, the flower pot cover (200) may be easily removed from the flower pot (100) and washed. The method of washing and cleaning may vary from one flower pot cover (200) to another seeing as the materials used to create the flower pot cover (200) are varying and may require different care. The method of removing a flower pot cover (200) from a flower pot (100) will greatly depend on the type of flower pot cover (200) use, various methods of securing flower pot covers to flower pots (100) is described in greater detail below, but first several advantages and benefits of various embodiments of the present flower pot cover (200) will be described.

As noted above with reference to traditional flower pots (100), common flower pots (100) are massed produced and are virtually identical. For this reason it is often difficult to distinguish one flower pot (100) from another, especially when only seeds are planted. The present system and method allows for flower pot covers (200) to be secured to traditional flower pots (100); wherein the flower pot covers (200) are configured with designs or markings allowing the user to easily identify and distinguish between several flower pots (100). Furthermore, according to one exemplary embodiment, the cover (200) may convey information about the planted seeds or growing plants. That is, two identical pots (100), planted with seeds, may not be distinguishable from one another. According to one embodiment of the present system and method, a flower pot cover may be configured to convey information regarding the contents of the flower pot (100). For example, a flower pot (100) containing catnip seeds may have a flower pot cover (200) portraying cats, fur, or something exemplifying cats, while a flower pot (100) containing pumpkin seeds may have a flower pot cover (200) with a jack-o-lantern on it. The different flower pot covers allow one flower pot to be distinguished from the other, as well as provide information regarding the contents of the flower pot.

While the flower pot cover (200) may be configured to convey information about the contents of the flower pot (100), according to one exemplary embodiment the flower pot cover (200) also provides structural support. According to one exemplary embodiment, the flower pot cover (200) is constructed of a material that is sufficiently strong to add structural integrity to the flower pot (100). Traditional flower pots (100) are often made of materials that easily break when dropped or are subjected to strong impacts. When flower pots break (100), the soil, water, and plant itself often spill and are damaged. A flower pot cover (200), according to one exemplary embodiment, is configured to protect the flower pot (100) from breaking. Additionally, in the event a flower pot (100) does break, the flower pot cover (200) is configured to secure the broken pot, soil, water, and the plant. Consequently, an uncovered flower pot (100) may fail structurally and result in a mess and/or a damaged plant, while according to one embodiment, a flower pot cover (200) will protect the plant and prevent messes in the event of structural failure of a the flower pot (100).

Several different embodiments offer varying levels of protection. A flower pot cover, according to one embodiment, is configured to include a bottom and side which are seamlessly connected to allow a complete water-tight securement of the soil, water, and plant. Alternatively, the flower pot cover, may only be a band surrounding the perimeter of the flower pot, while not including a bottom. A flower pot cover configured as only a band around the perimeter of a flower pot offers some support and protection against breakage, but does not prevent soil and water from escaping in the event of structural failure. A subsequent description of various flower pot cover configurations will further clarify the varying protection and support offered by each of the flower pot covers.

While a flower pot cover (200) will help support a flower pot (100) in the event of structural failure and also prevent leakage of the contents of the pot upon breaking, according to on exemplary embodiment, the flower pot cover (200) is water-tight and offers continued securement of the contents. As can be seen in FIG. 1B, a traditional flower pot (100) may have a hole (140) in the distal end (130) of the flower pot. This hole (140) is typically placed in the bottom (130) of the flower pot (100), but may alternatively be placed anywhere near the bottom (130) of the flower pot (100). The hole (140) is typically intended to release excess water from the pot (100); any overwatering will not remain in the soil saturating and damaging the plant's roots, but rather will be drained out. While this may be an advantage in some scenarios, often a flower pot (100) is placed in a location where the owner does not want any water to drain out of the pot (100) onto the surface upon which the pot (100) is disposed. According to one exemplary embodiment, a flower pot cover (200) is specifically configured to contain any water that escapes the hole (140) of the flower pot (100). Any material or liquid that escapes the hole (140) will be contained within the cover (200); necessarily, according to this embodiment, the flower pot cover (200) includes a bottom connected to the walls (210) of the flower pot cover (200).

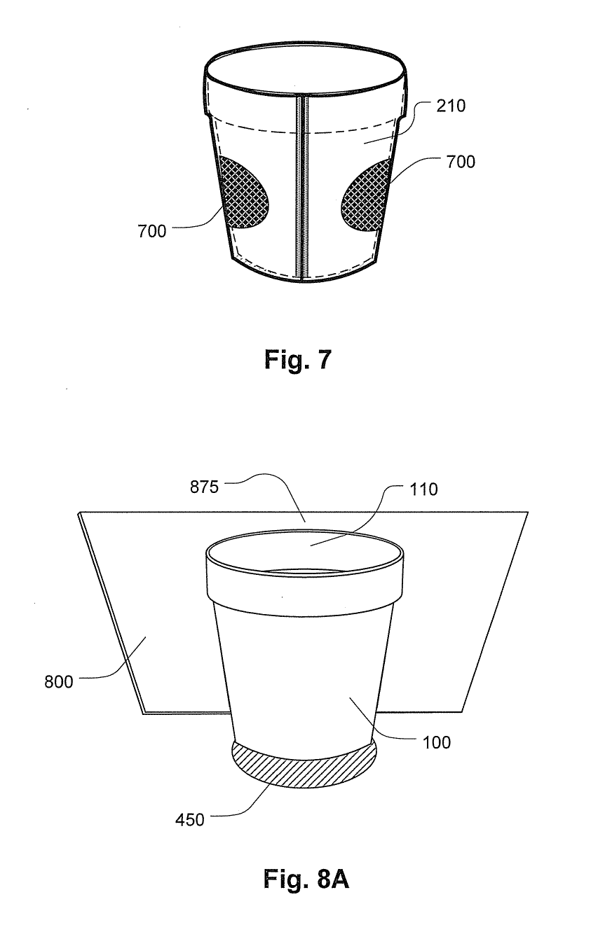

Additionally, as described above, flower pots (100) are often constructed of materials that easily break when dropped, such as clays and ceramics. These same materials are often hard to handle in that they do not offer a good grip for the handler, and when wet are slippery. In remedy, according to one exemplary embodiment, the flower pot cover (200), is inherently, or specifically configured to offer a better grip to the handler. It is often necessary for plant owners to move a flower pot (100) from one location to another; traditional flower pots (100) that are slippery or offer no gripping area may be dropped resulting in spilling the soil and water, and/or damaging the plant within. A plant owner may be benefited greatly through the use of a flower pot cover (200) as, according to one embodiment of the present exemplary system and method, the flower pot cover (200) will be secured to the flower pot and offer a superior gripping surface. The improved gripping surface will result in fewer accidents wherein the pot handler drops or spills the contents of the flower pot (100). FIG. 7 clearly shows a flower pot cover (200) disposed about a flower pot (100), wherein the flower pot cover (200) is configured with areas designed to provide superior grip (700). Further details regarding FIG. 7 and other manners of securing flower pot covers (200) to flower pots (100) will be discussed below subsequent to the description of how a flower pot cover (200) may also convey gift sentiments, communicate emotions, and provide tactile feedback.

Also, according to one exemplary embodiment, a flower pot cover (200) is configured specifically for use with biodegradable flower pots, such as coconut fiber pots. According to this embodiment, the flower pot cover decreases the decay rate of the coconut fiber flower pot. The decay rate of a biodegradable flower pot may be reduced by a flower pot cover (200) due to the flower pot cover (200) blocking sunlight or preventing bacteria and decomposition of the coconut fiber pot. A flower pot cover (200) may be specifically configured to reduce the amount of sunlight contacting the flower pot (100), and/or comprise of materials beneficial in reducing the bacteria or decomposition of biodegradable flower pot.

Similar to the description above relating to features configured to distinguish one flower pot (100) from another, according to an alternative embodiment, the flower pot cover (200) is configured to provide identifying features conveying emotional or sentimental attachment. Flower pot covers (200) might have photos or other designs that will allow a gift giver to convey specific emotions or sentiments by giving a flower pot (100) with a specially tailored flower pot cover (200) to an intended recipient. Alternatively an owner of a flower pot (100) may utilize a flower pot cover (200) intended to convey a specific emotion, relate to a certain experience or person, or otherwise invoke sentiments within viewers of the flower pot.

In addition to being able to convey information, whether sentimental or instructional, a flower pot cover, according to another embodiment, is configured with designs providing tactile feedback. These decorational flower pot covers (200) may be handled and touched and thereby communicate through tactile feedback information regarding the plant within, the plants history, the owner, or the giver of the flower pot (100). Flower pot covers providing tactile feedback, according to several embodiments, may not communicate information, but be intended exclusively for enjoyment or to correspond with surrounding décor. A flower pot cover (200) providing tactile feedback may be especially useful to the visually impaired, who typically obtain information through touch rather than sight. The tactile feedback may also be tailored specifically to children.

### Methods of Securement and Construction

A flower pot (100) is represented in FIGS. 1A and 1B; however, it should be understood that several alternative embodiments are possible. As illustrated, the flower pot (100) has a distal end (130) and a proximal end (120). As shown in the figure the flower pot (100) has a decorational ring (110) disposed about the proximal end. Alternative embodiments may or may not include the ring (110) and may also incorporate other features. As shown in FIG. 1B, a bottom perspective view illustrates the hole (140) on the distal end (130) useful for draining excess water from the flower pot (100).

FIGS. 2A-2C illustrate views of a flower pot cover (200) not secured to a flower pot (100). It can be seen that the flower pot cover (200) is substantially the same shape as the flower pot (100). That is, it is shown as a tapered cylinder having an inner wall (220) and an outer wall (210). The diameter of the proximal end (250) of the flower pot cover (200) corresponds to the diameter of the proximal end (120) of the flower pot (100). Likewise, the diameters of the distal ends (130, 260) of both the flower pot (100) and the flower pot cover (200) also correspond. According to the exemplary embodiments of FIGS. 2A-2C, the flower pot cover (200) does not incorporate a bottom, while alternative embodiments described below include a bottom in addition to the side wall. It is also understood that the flower pot (100) may be of varying shapes and sizes; likewise, the flower pot cover (200) may be configured to be any shape so as to correspond to a flower pot (100).

According to one exemplary embodiment, the flower pot cover (200) as shown may have an elastic member disposed within the material, or the material itself may be inherently elastic. Accordingly, the flower pot cover (200) is configured to be placed around a flower pot (100) by stretching the flower pot cover (200), placing the flower pot cover (200) around the flower pot (100), and letting the elasticity of the material or a elastic portion of the material secure the flower pot cover (200) to the flower pot (100).

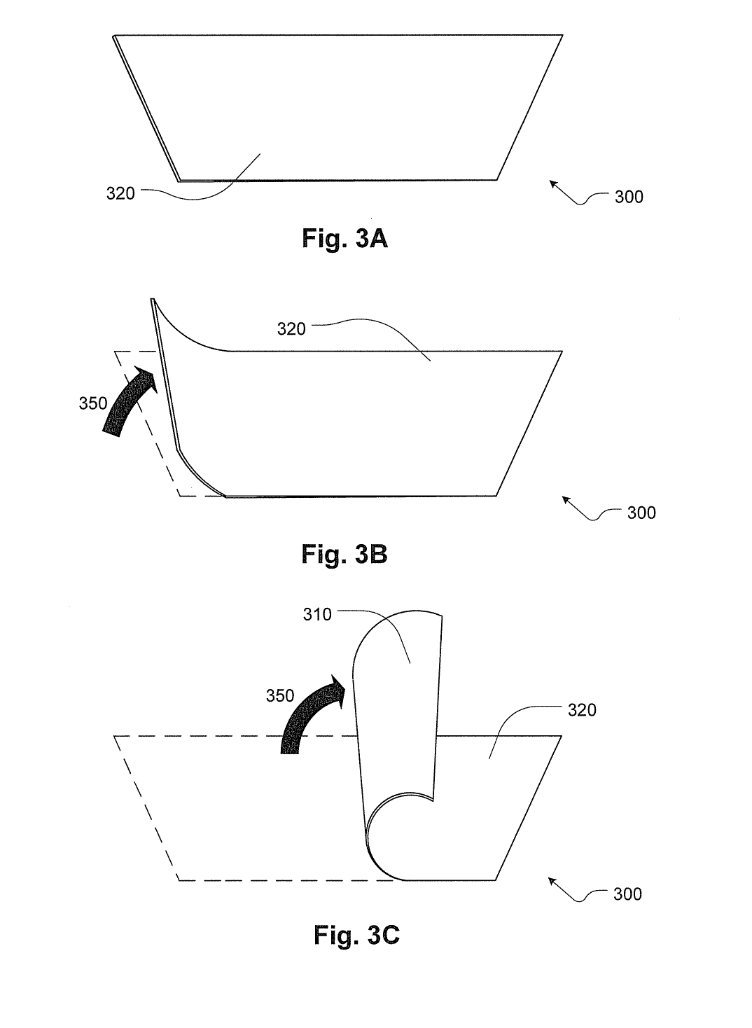

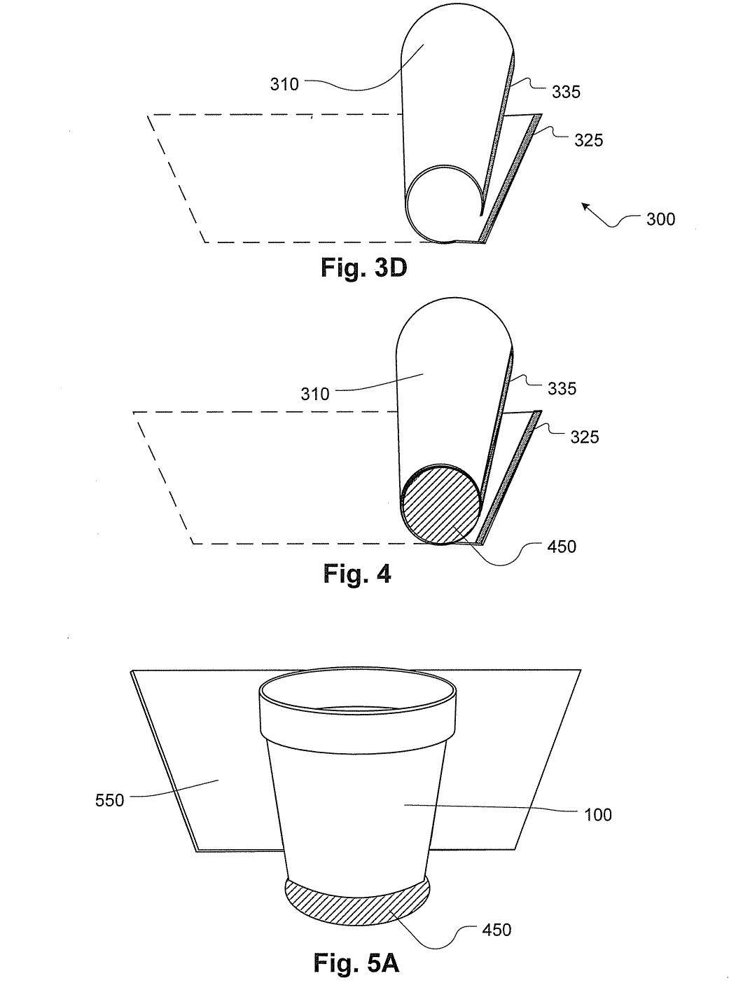

FIGS. 3A-3C illustrate the process of forming a flower pot cover (200), according to one exemplary embodiment. As shown in FIG. 3A, a trapezoidal section of suitable material (300) is cut out. Subsequently, as shown in FIG. 3B, a rolling motion (350) is preformed to roll the trapezoidal section of material (300). Further rolling (350) attains a partially rolled flower pot cover as shown in FIG. 3C. It can be seen in the figure that the inner wall (320) is almost circular, and the outer wall (310) is now visible. By continuing to roll the material (300), the two ends will meet thereby creating the truncated conical shape as shown in FIG. 2B. The two ends must be secured to one another through a connecting means.

FIG. 3D illustrates the same rolled material of FIG. 3C further illustrating an additional connecting means, a first connector (325) and a second connector (335). Upon rolling the material (300) completely, the first connector (325) is secured to the second connector (335), and the material now forms the a truncated conical section. Additionally, according to one exemplary embodiment, the material (300) may further comprise a bottom (450) that is secured to the distal end of the completely rolled material (300). Subsequent to the material (300) being rolled, and optionally securing a bottom (450) to the material, the completed flower pot cover (200) may be secured to a flower pot (100).

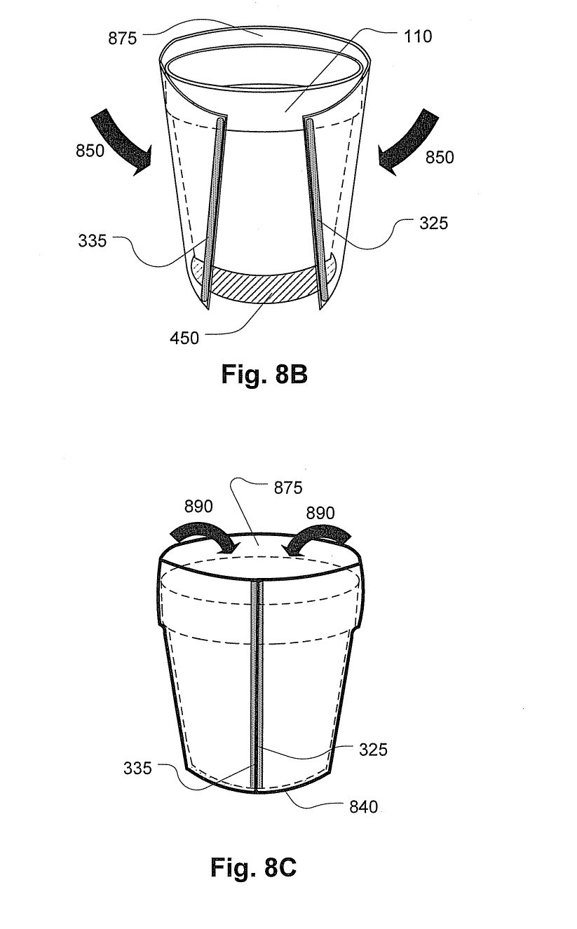

While previously described as being elastically secured to the flower pot (100), there are a number of ways the flower pot cover (200) might be secured to a flower pot, including, but not limited to, strings, glue, crimps, adhesives, welds, solder, rivets, clips, Velcro™ and many other conceivable methods. According to one exemplary embodiment, the proximal end (250) of the flower pot cover (200) is higher than the proximal end (120) of the flower pot (100). According to this exemplary embodiment, the flower pot cover (200) may be secured to the flower pot (100) by folding the top portion of the flower pot cover (200) into the flower pot (100). This is illustrated by, and will be described in greater detail below regarding FIGS. 8A-8C.

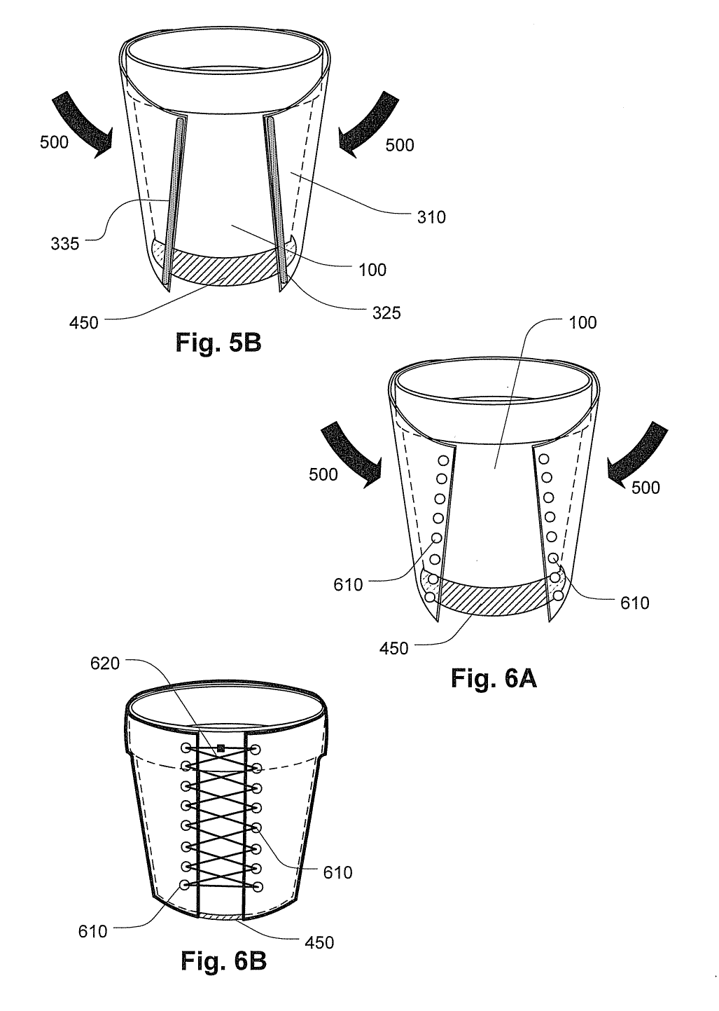

As many materials do not posses inherent elastic characteristics and sewn in elastic bands may not be viable or desired, there are many alternative methods of securing a flower pot cover (200) to a flower pot (100). One exemplary embodiment of such a method is illustrated in FIG. 5A. As illustrated, a flower pot (100) is in place with a trapezoidal section of material (550) behind it. According to one exemplary embodiment, as illustrated, a bottom (450) is in place. According to this exemplary embodiment, the trapezoidal section of material (550) will be wrapped around the flower pot (100) and subsequently secured to the flower pot (100). The bottom (450) will also be secured to the trapezoidal rolled section (300), thereby creating a flower pot cover (200) complete with a bottom (450). According to one exemplary embodiment, the flower pot cover (200) includes a bottom (450) wherein the bottom does not necessarily comprise the same material or materials used in the side portion of the flower pot cover. It may be useful to form the bottom (450) of the flower pot cover (200) from a material more capable of protecting the surface upon which the flower pot (100) is disposed that the material used to form the side portion of the flower pot cover (200). The bottom (450) may also be configured to provide additional functions such as insulation from, or to adhere to, the surface upon which the flower pot (100) is disposed. Furthermore, according to one exemplary embodiment, the bottom (450) may include a wafer configured to absorb excess water that leeches from the flower pot (100) while preventing the excess water from transferring to the surface upon which the flower pot is resting. For example, according to one exemplary embodiment, the bottom (450) may include a cylindrical shaped member having an absorbent core material and a moisture barrier on the distal surface that will contact a surface upon which the flower pot (100) is placed. According to one exemplary embodiment, the absorbent material may receive any extra water that passes through the pot, retains the water, and allows the water to be re-absorbed through capillary action to the bottom of the pot when needed. Consequently, this exemplary embodiment actually increases the water content absorption level of the flower pot (100).

As described above, several exemplary embodiments, are configured wherein the seams and the materials used are strong enough to give structural support to the flower pot (100) and/or provide a water-proof flower pot cover to the flower pot (100). Consequently, it may be important that all the seams, between the two ends of the trapezoidal material (300), and the bottom (450) are water tight and structurally sound. According to one alternative embodiment, the entire flower pot cover is constructed as one piece and slides onto the flower pot (100) where it is subsequently secured. A one piece flower pot cover, may be secured to the flower pot, by elasticity, bands, strings, crimps, adhesives, glues, and other securement methods.

FIG. 5B illustrates the trapezoidal section (550) being wrapped around a flower pot (100) illustrated by an arrow (500). The material (550) is shown with a connecting means (325, 335) for securing the two ends of material (550). The connecting means may be any number of surfaces capable of securing the two ends, including, but not limited to, glue, Velcro™, buttons, zippers, snaps, clips, or interlocking members. Alternatively, as illustrated in FIG. 6A, according to one exemplary embodiment, the connecting means comprises of eyelets (610), wherein the eyelets (610) are configured to receive a cord (620). The cord (620) is passed through the eyelets (610) and thereby secures the flower pot cover to the flower pot (100) as shown in FIG. 6B.

Independent of how the flower pot cover (200) is secured to the flower pot (100), the functionality the flower pot cover (200) is preserved, according to any one of the various embodiments and methods of securement. A number of advantages may be gained by adding a flower pot cover (200) to a flower pot (100), including the benefits described above. FIG. 7 illustrates one benefit that was described above, namely a superior gripping surface. As shown, gripping surfaces (700) are disposed on an outer surface (210) of a flower pot cover (200). As illustrated the flower pot (100) is completely hidden, and is drawn in dashed lines to represent that it is behind the flower pot cover (200). Many other features may be present on the outer or inner surfaces of the flower pot cover, including, but not limited to, features that, communicate information regarding the plant, communicate information regarding the owner or giver of the plant, are configured to accent surrounding décor, provide an insulational layer, provide structural support to the flower pot, prevent leakage of the contents of the flower pot, and/or provide tactile feedback. Not all of these features are illustrated because of the number of variations that exist. However, according to various embodiments, each of the functional features described above may be used exclusive of the others in a flower pot cover, or alternatively one or more functional features may be incorporated into a single embodiment of a flower pot cover.

Finally, as another exemplary method of securing a flower pot cover (200) to a flower pot (100) FIGS. 8A-8C illustrate a flower pot cover (200) slightly larger than the flower pot (100), according to one exemplary embodiment. As illustrated in FIG. 8A, a flower pot cover (800) is slightly larger than the flower pot (100) as is illustrated by the excess material (875) between the top most surface of the flower pot (100) and the top most surface of the flower pot cover (800). Similar to previous embodiments, a bottom (450) is secured to the side material section (800). As illustrated in FIG. 8B, the material (800) is wrapped around the flower pot (100) as is shown by arrows (850). The wrapped material (800), as apparent, is slightly taller than the flower pot (100) and consequently the excess material (875) is seen. According to one exemplary embodiment, the excess material (875) extending above the flower pot (100) is left extended and, after securement of the of the material (800) to the flower pot (100), a finished flower pot and flower pot cover is shown in FIG. 8C. However, according to one exemplary embodiment, the excess material is tucked within the flower pot (100) as is illustrate by the arrows (890). According to one embodiment, the tucked material is instrumental in securing the flower pot cover (800) to the flower pot (100).

As has been illustrated and described, the flower pot (100) and corresponding flower pot cover (200) have been described substantially as a tapered cylinder, or truncated conical section. This is according to one exemplary embodiment, it is within the scope of the presently disclosed system and method to create a flower pot cover of any shape necessary to accommodate for various shapes and sizes of flower pots. As previously mentioned the flower pot cover may also be configured for use with other pots or containers, not exclusively containers and pots used for plants.

Additionally, in the preceding description and throughout the claims it is understood that the terms material(s) and fabric(s) include, but are not limited to, leathers, cloths, synthetics, plastics, cements, ceramics, ribbons, metals, furs, hairs, feathers, both transparent and opaque materials, and other suitable materials capable of forming a flower pot cover.

The preceding description has been presented only to illustrate and describe exemplary embodiments of the present system and method. It is not intended to be exhaustive or to limit the system and method to any precise form disclosed. Many modifications and variations are possible in light of the above teachings. It is intended that the scope of the system and method be defined by the following claims.

What is claimed is:

1. An apparatus comprising:
a flower pot;
a cover disposed about an outer surface of said flower pot,
wherein said cover is configured to be securable to said flower pot and removable from said flower pot.

2. The apparatus of claim 1, wherein said cover is washable.

3. The apparatus of claim 1, wherein said cover is reversible.

4. The apparatus of claim 1, wherein said cover comprises a fabric.

5. The apparatus of claim 1, further comprising securing elements associated with said cover;
wherein said securing elements are configured to secure said cover to said flower pot and provide structural support sufficient to retain the contents of said flower pot upon structural failure of said flower pot.

6. The apparatus of claim 1, further comprising at least one decorative component configured to provide visual identification information regarding the contents of said flower pot.

7. The apparatus of claim 1, wherein said cover further comprises:
a base;
wherein said base comprises an absorbent core; and
a water barrier formed on at least one surface of said absorbent core.

8. The apparatus of claim 6, wherein said at least one decorative component is configured to provide information regarding a sentimental value of said flower pot.

9. The apparatus of claim 6, wherein said at least one decorative component is configured to convey a sentiment of a giver of said pot.

10. The apparatus of claim 6, wherein said at least one decorative component is configured to provide information via tactile feedback.

11. The apparatus of claim 1, wherein said cover is configured to maintain a shape and integrity of said flower pot.

12. The apparatus of claim 1, wherein said cover is configured to provide a non-slip surface for handling said flower pot.

13. The apparatus of claim 1, wherein said cover is configured to contain moisture and soil within said flower pot.

14. An apparatus comprising:
a cover configured to be disposed around an outer perimeter of a flower pot;
wherein said cover is configured to be secured to said flower pot and capable of being removed from said flower pot; and
wherein said cover is reversible, washable, and further comprises decorative components configured to provide visual and tactile information making said apparatus distinguishable from other apparatuses.

15. The apparatus of claim 14, wherein said decorative components are configured to convey information regarding the contents of said flower pot.

16. The apparatus of claim 14, wherein said decorative components are configured to provide information regarding the sentiments of the giver of said apparatus or its contents toward the recipient of said apparatus or its contents.

17. The apparatus of claim 14, wherein said cover is configured to protect a shape and integrity of said flower pot.

18. An apparatus comprising:
a flower pot;
a removable fabric cover disposed about an outer perimeter of said flower pot;
said removable fabric cover being washable, reversible and provide a non-slip surface for handling said flower pot.

19. The apparatus of claim 18, wherein said removable fabric cover is configured to contain moisture and soil in said flower pot.

20. The apparatus of claim 19, wherein said removable fabric cover further comprises at least one decorative component configured to provide visual and tactile information.
